(19) United States
(12) Patent Application Publication
(10) Pub. No.: US 2025/0054010 A1
(43) Pub. Date: Feb. 13, 2025

(54) SYSTEM AND METHOD FOR CONTROLLING ENVIRONMENTAL FACTOR FOR AREA

(71) Applicant: HITACHI, LTD., Tokyo (JP)

(72) Inventors: Lan LAN, Singapore (SG); Wujuan LIN, Singapore (SG)

(21) Appl. No.: 18/719,860

(22) PCT Filed: Jan. 24, 2022
(86) PCT No.: PCT/SG2022/050032

§ 371 Date: Jun. 14, 2024

(51) Int. Cl. G06Q 30/0207; G06N 20/00; G06Q 30/0201; G06Q 30/0202; G06Q 50/06

(52) U.S. Cl. CPC G06Q 30/0207; G06N 20/00; G06Q 30/0202; G06Q 30/0206; G06Q 50/06

(57) ABSTRACT

A system for controlling an environmental factor for an area is provided. According to various embodiments, the system comprises an environmental factor control device connectable to an electronic device configured to receive an input from a user. The environmental factor control device is configured to predict at least one of an energy saving and an estimated reward associated with one or more values of the environmental factor, send prediction information about the at least one of the energy saving and the estimated reward associated with the one or more values to the electronic device, receive a selected value among the one or more values from the electronic device, determine a value of the environmental factor for the area based on the selected value, and calculate a reward for the user based on the determined value of the environmental factor for the area and the selected value.

### TECHNICAL FIELD

Various embodiments relate to a system and a method for controlling an environmental factor for an area.

### BACKGROUND

For a building system control in a shared space, it may be important to determine an optimal value of an environmental factor, for example, an optimal set point, to minimise an energy consumption and operational costs while maintaining overall user satisfactions. Because, if the set point is not optimal, it may result in energy wastage. In addition, occupants of the space may want a comfortable environment, and the suboptimal set point may result in overall dissatisfaction of the occupants. Moreover, building/business owners, who are main stakeholders of energy costs, may want to minimise the associated operational cost.

However, it may be difficult to determine the optimal set point in the shared space because of diverse user preferences. For example, in a context of temperature set point control in the shared space, it may be difficult to determine an optimal temperature set point. Because, thermal sensation may vary from individual to individual and also vary with time due to a change of weather, activity levels, and internal heat gains. Hence, when the building/business owners and/or facility managers adjust the set point for better energy efficiency, it may be difficult to foresee consequences, for example, a change of overall user satisfaction.

Therefore, there may be a need to provide a system and a method for controlling the environmental factor for the shared space, which may collaboratively address user satisfaction concerns, energy concerns and cost concerns in the shared space.

### SUMMARY

According to various embodiments, a system for controlling an environmental factor for an area is provided. The system comprises: an environmental factor control device connectable to an electronic device configured to receive an input from a user, wherein the environmental factor control device is configured to predict at least one of an energy saving and an estimated reward associated with one or more values of the environmental factor, send prediction information about the at least one of the energy saving and the estimated reward associated with the one or more values to the electronic device, receive a selected value among the one or more values from the electronic device, determine a value of the environmental factor for the area based on the selected value, and calculate a reward for the user based on the determined value of the environmental factor for the area and the selected value.

In some embodiments, the environmental factor control device is configured to receive the selected value and a selected contribution for the selected value from the electronic device, determine the value based on the selected value and the selected contribution, and calculate the reward for the user based on the determined value, the selected value and the selected contribution.

In some embodiments, the environmental factor control device is configured to determine the value using a weighted average calculation function based on the selected value and the selected contribution.

In some embodiments, the environmental factor control device is configured to use an energy prediction model to predict the at least one of the energy saving and the estimated reward.

In some embodiments, the environmental factor control device is further configured to be connectable to an environmental factor service provision device configured to operate at a value of the environmental factor for the area, and wherein the environmental factor control device is further configured to send the determined value of the environmental factor for the area to the environmental factor service provision device, and predict a baseline energy consumption for the area where the environmental factor service provision device operates at the determined value, using the energy prediction model based on at least one of an energy consumption, a baseline value of the environmental factor, building design data, and operation condition data.

In some embodiments, the energy prediction model is a machine-learning based model.

In some embodiments, the system further comprises an energy measuring device configured to measure an energy consumption for the area where the environmental factor service provision device operates at the determined value, and provide the information about the measured energy consumption to the environmental factor control device.

In some embodiments, the environmental factor control device is further configured to calculate a total energy saving based on the measured energy consumption and the predicted baseline energy consumption.

In some embodiments, the environmental factor control device is further configured to calculate a total cost saving based on the calculated total energy saving.

In some embodiments, the environmental factor control device is configured to calculate the reward for the user using a distribution model based on the calculated total cost saving, the determined value, the selected value and the selected contribution.

In some embodiments, the environmental factor control device is further configured to observe a change between an initial value of the environmental factor for the area at which the environmental factor service provision device operates as a first setting and the determined value of the environmental factor for the area at which the environmental factor service provision device operates as a second setting and a change of the total cost saving, and update the distribution model using a reinforcement learning function based on the observation.

In some embodiments, the environmental factor control device is further configured to send the calculated reward for the user and the determined value to the electronic device.

According to various embodiments, a method for controlling an environmental factor for an area is provided. The method includes: operating an environmental factor service provision device at a first value of the environmental factor for the area; predicting at least one of an energy saving and an estimated reward associated with one or more values of the environmental factor; sending prediction information about the at least one of the energy saving and the estimated reward associated with the one or more values to an electronic device, so that the electronic device outputs the prediction information associated with the one or more values; receiving a selected value among the one or more values from a user, via the electronic device; determining a second value of the environmental factor for the area based on the selected value; operating the environmental factor service provision device at the second value of the environmental factor for the area; and calculating a reward for the user based on the second value and the selected value.

In some embodiments, receiving the selected value from the user comprises: receiving the selected value and a selected contribution for the selected value from the user; determining the second value comprises: determining the second value based on the selected value and the selected contribution; and calculating the reward for the user comprises: calculating the reward for the user based on the second value, the selected value and the selected contribution.

In some embodiments, determining the second value includes: determining the second value using a weighted average calculation function based on the selected value and the selected contribution.

In some embodiments, the method further includes: displaying the prediction information in a form of a user interface on the electronic device, to allow the user to input the selected value among the one or more values on the user interface.

In some embodiments, predicting the at least one of the energy saving and the estimated reward associated with the one or more values includes: using an energy prediction model to predict the at least one of the energy saving and the estimated reward.

In some embodiments, the method further includes: predicting a baseline energy consumption for the area where the environmental factor service provision device operates at the second value, using the energy prediction model based on at least one of an energy consumption, a baseline value of the environmental factor, building design data, and operation condition data.

In some embodiments, the energy prediction model is a machine-learning based model.

In some embodiments, the method further includes: receiving, from an energy measuring device, information about a measured energy consumption for the area where the environmental factor service provision device operates at the second value.

In some embodiments, the method further includes: calculating a total energy saving based on the measured energy consumption and the predicted baseline energy consumption.

In some embodiments, the method further includes: calculating a total cost saving based on the calculated total energy saving.

In some embodiments, calculating the reward for the user includes: calculating the reward for the user using a distribution model based on the calculated total cost saving, the second value, the selected value and the selected contribution.

In some embodiments, the method further includes: observing a change between the first value and the second value and a change of the total cost saving; and updating the distribution model using a reinforcement learning function based on the observation.

In some embodiments, the method further includes: sending the calculated reward for the user and the second value to the electronic device.

According to various embodiments, a system for controlling an environmental factor for an area is provided. The system comprises: an electronic device configured to receive an input from a user; an environmental factor service provision device configured to operate at a first value of the environmental factor for the area; and an environmental factor control device connectable to the electronic device and the environmental factor service provision device, wherein the environmental factor control device is configured to predict at least one of an energy saving and an estimated reward associated with one or more values of the environmental factor, and send prediction information about the at least one of the energy saving and the estimated reward associated with the one or more values to the electronic device, the electronic device is configured to output the prediction information associated with the one or more values, receive a selected value among the one or more values from the user, and send the selected value to the environmental factor control device, the environmental factor control device is further configured to determine a second value of the environmental factor for the area based on the selected value, and send the second value to the environmental factor service provision device, the environmental factor service provision device is further configured to operate at the second value of the environmental factor for the area upon receiving the second value from the environmental factor control device, and the environmental factor control device is further configured to calculate a reward for the user based on the second value and the selected value.

In some embodiments, the electronic device is configured to receive the selected value and a selected contribution for the selected value from the user, and send the selected value and the selected contribution to the environmental factor control device; and the environmental factor control device is configured to determine the second value based on the selected value and the selected contribution, and calculate the reward for the user based on the second value, the selected value and the selected contribution.

In some embodiments, the electronic device is configured to display the prediction information associated with the one or more values in a form of a user interface, to allow the user to input the selected value among the one or more values on the user interface.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 is a block diagram illustrating a system according to various embodiments.

FIG. 2 is a flow diagram illustrating a method according to various embodiments.

FIG. 3 is a sequence diagram illustrating interactions between a user application of an electronic device, an environmental factor control device, an environmental factor service provision device, and an energy measuring device.

FIG. 4 is a flow diagram illustrating a method according to various embodiments.

FIG. 5 is a flow diagram illustrating a method according to various embodiments.

FIG. 6 is a flow diagram illustrating a method according to various embodiments.

FIG. 7 is a table diagram illustrating a calculation of weight for determining a set point.

FIG. 8 is a flow diagram illustrating a method according to various embodiments.

FIG. 9 is an image diagram illustrating a method according to various embodiments.

FIG. 10A is an image diagram illustrating a user experience screen of an electronic device according to various embodiments.

FIG. 10B is an image diagram illustrating a user experience screen of an environmental factor control device according to various embodiments.

FIG. 11 is a block diagram illustrating an environmental factor control device according to various embodiments.

### DESCRIPTION

Embodiments described below in context of the method are analogously valid for the system, and vice versa. Furthermore, it will be understood that the embodiments described below may be combined, for example, a part of one embodiment may be combined with a part of another embodiment.

It will be understood that any property described herein for a specific device may also hold for any device described herein. Furthermore, it will be understood that for any device described herein, not necessarily all the components described must be enclosed in the device, but only some (but not all) components may be enclosed.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, structure or any part of any device or structure. In addition, the singular terms “a”, “an”, and “the” include plural references unless context clearly indicates otherwise. Similarly, the word “or” is intended to include “and” unless the context clearly indicates otherwise.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In order that the invention may be readily understood and put into practical effect, various embodiments will now be described by way of examples and not limitations, and with reference to the figures.

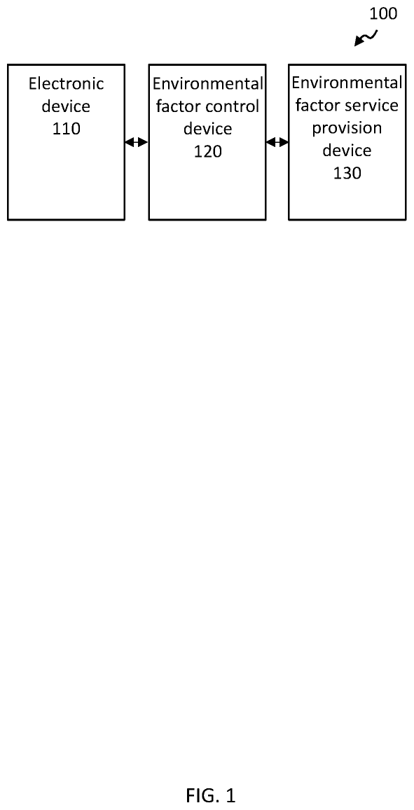

FIG. 1 is a block diagram illustrating a system 100 according to various embodiments. The system 100 may include an electronic device 110, an environmental factor control device 120 and an environmental factor service provision device 130.

The system 100 may receive an occupant's (also referred to as a “user”) preferred value of at least one environmental factor for an area and control the environmental factor service provision device 130 based on the user's preferred value.

In some embodiments, the area may include a shared space for a plurality of occupants (also referred to as “users”). For example, the area may include an enclosed space, for example, a building.

In some embodiments, the environmental factor may include at least one building control parameter. The environmental factor may include, but not be limited to, at least one of the following: a temperature of a heating and/or cooling system, a humidity level, a ventilation rate, a light level (for example, turning on/off, dimming, etc.), and any combination thereof. In some embodiments, the environmental factor may be referred to as a “set point”. For example, where the environmental factor is the temperature, the user's preferred value may be the user's preferred temperature set point.

In some embodiments, the electronic device 110 may belong to the user. In some embodiments, the electronic device 110 may receive an input from the user. The user may input the user's preferred value of the environmental factor for the area into the electronic device 110. In some other embodiments, the electronic device 110 may be used by the user, but may not belong to the user. For example, the electronic device 110 may include a central dashboard (for example, a touchscreen device fixed in a service area) which allows multiple users to view and submit their inputs, for example, preferred values of the environmental factor for the area. In some embodiments, the electronic device 110 may be capable of a data communication with the environmental factor control device 120. The electronic device 110 may transmit wireless signals to the environmental factor control device 120 and/or receive wireless signals from the environmental factor control device 120. In some embodiments, the electronic device 110 may send the user's preferred value of the environmental factor to the environmental factor control device 120. The electronic device 110 may include, but not be limited to, at least one of the following: a mobile phone, a tablet computer, a laptop computer, a desktop computer, a head-mounted display and a smart watch.

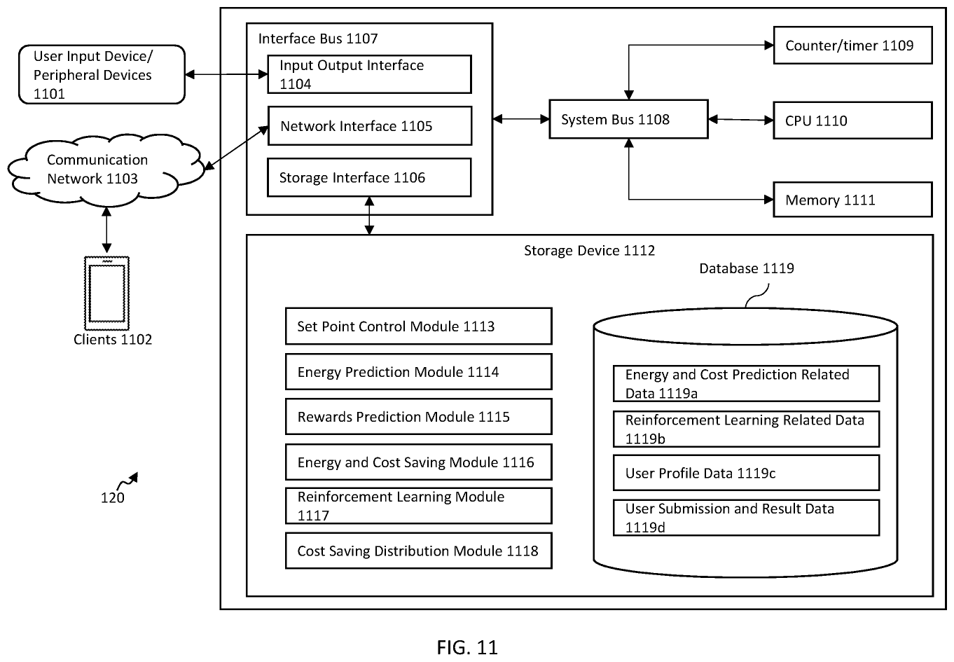

In some embodiments, the environmental factor control device 120 may referred to as a control system. In some embodiments, the environmental factor control device 120 may belong to building/business owners (and/or facility managers). For example, the environmental factor control device 120 may include at least one of one or more user input device/peripheral devices, one or more client devices, an interface bus, a system bus, a storage device, a counter/timer, a CPU, and a memory (as will be described with FIG. 11). The environmental factor control device 120 may control the environmental factor service provision device 130. In some embodiments, the environmental factor control device 120 may receive the user's preferred value from the electronic device 110 and control the environmental factor service provision device 130 to operate at a certain value of the environmental factor for the area. In some embodiments, the environmental factor control device 120 may be connectable to the electronic device 110 and to the environmental factor service provision device 130. The environmental factor control device 120 may be capable of a data communication with the environmental factor service provision device 130. The environmental factor control device 120 may transmit wireless signals to the environmental factor service provision device 130 and/or receive wireless signals from the environmental factor service provision device 130.

In some embodiments, the environmental factor service provision device 130 may be referred to as building service system (BSS). In some embodiments, the environmental factor service provision device 130 may operate at the certain value of the environmental factor for the area, by the control of the environmental factor control device 120. The environmental factor service provision device 130 may include, but not be limited to, at least one of the following: at least one HVAC (heating, ventilation, and air conditioning) system, at least one heating and air conditioning system, at least one AC (air conditioning) system, at least one humidifier, at least one ventilator, at least one light control system, and any combination thereof. For example, where the environmental factor is the temperature for cooling, the environmental factor service provision device 130 may be the air conditioning system.

In some embodiments, the environmental factor service provision device 130 may operate at a certain value (also referred to as a “first value” or an “initial value”) of the environmental factor for the area. For example, the environmental factor service provision device 130 may operate at the first temperature set point. As an example, the environmental factor service provision device 130 may be the air conditioning system.

In some embodiments, the environmental factor control device 120 may predict at least one of an energy saving and an estimated reward associated with one or more values of the environmental factor. For example, the environmental factor control device 120 may predict the energy saving and estimated reward associated with a plurality of temperature set points. For the air conditioning system, as the temperature set point is higher, more energy may be saved.

In some embodiments, the environmental factor control device 120 may send prediction information about the at least one of the energy saving and the estimated reward associated with the one or more values to the electronic device 110. For example, the environmental factor control device 120 may send the prediction information including the predicted energy saving and the estimated reward associated with the plurality of temperature set points to the electronic device 110.

In some embodiments, the electronic device 110 may output the prediction information associated with the one or more values. In some embodiments, the electronic device 110 may display the prediction information associated with the one or more values in a form of a user interface, to allow the user to input the user's preferred value (also referred to as a “selected value”), for example, the user's preferred temperature set point, on the user interface. For example, the user may select one value among the one or more values on the user interface. As an example, the user may select one temperature set point among the plurality of temperature set points. In some embodiments, the electronic device 110 may receive the selected value among the one or more values from the user, and send the selected value to the environmental factor control device 120.

In some embodiments, the system 100 may include a plurality of electronic devices 110 each belonging to each user of a plurality of users, for example, a first electronic device belonging to a first user and a second electronic device belonging to a second user. Each electronic device of the plurality of electronic devices 110 may send a corresponding user's selected value to the environmental factor control device 120. In some embodiments, the first electronic device may send a first user's selected value to the environmental factor control device 120, and the second electronic device may send a second user's selected value to the environmental factor control device 120. For example, the first electronic device may send a first user's preferred temperature set point to the environmental factor control device 120, and the second electronic device may send a second user's preferred temperature set point to the environmental factor control device 120.

In some embodiments, the environmental factor control device 120 may receive the selected value from the electronic device 110. In some embodiments, the environmental factor control device 120 may determine an updated value (also referred to as a “second value” or a “determined value”) of the environmental factor for the area based on the selected value. In some embodiments, the environmental factor control device 120 may then send the determined second value to the environmental factor service provision device 130.

In some embodiments, the environmental factor control device 120 may receive each user's selected value from the plurality of electronic devices 110. In some embodiments, the environmental factor control device 120 may determine the second value of the environmental factor for the area based on the each user's selected value. In some embodiments, the environmental factor control device 120 may receive the first user's selected value from the first electronic device and the second user's selected value from the second electronic device. In some embodiments, the environmental factor control device 120 may determine the second value based on the first user's selected value and the second user's selected value. For example, the environmental factor control device 120 may determine the updated temperature set point for a next time step (also referred to as “time slot” or “period”), based on the first user's preferred temperature set point and the second user's preferred temperature set point.

In some embodiments, the environmental factor service provision device 130 may operate at the second value of the environmental factor for the area upon receiving the second value from the environmental factor control device 120. For example, the air conditioning system may operate at the updated temperature set point in the next time step.

In some embodiments, the environmental factor control device 120 may calculate a reward for the user based on the second value and the selected value. The reward may include a monetary compensation to be given to the user.

In some embodiments, the environmental factor control device 120 may calculate each user's reward based on the second value of the environmental factor and the each user's selected value. In some embodiments, the environmental factor control device 120 may calculate a first user's reward based on the second value of the environmental factor and the first user's selected value, and calculate a second user's reward based on the second value of the environmental factor and the second user's selected value. For example, the environmental factor control device 120 may calculate the first user's reward based on the updated temperature set point and the first user's preferred temperature set point, and the second user's reward based on the updated temperature set point and the second user's preferred temperature set point.

In some embodiments, the electronic device 110 may receive the selected value and a selected contribution for the selected value from the user, and send the selected value and the selected contribution to the environmental factor control device 120. The contribution may include a monetary contribution associated with the user's selected value to be paid to the environmental factor control device 120 by the user. For example, the contribution may be an amount of payment from the user to the environmental factor control device 120. The environmental factor control device 120 may belong to a building/business owner.

In some embodiments, each electronic device of the plurality of electronic devices 110 may send the corresponding user's selected value and selected contribution to the environmental factor control device 120. In some embodiments, the first electronic device may send the first user's selected value and the first user's selected contribution to the environmental factor control device 120, and the second electronic device may send the second user's selected value and the second user's selected contribution to the environmental factor control device 120. For example, the first electronic device may send the first user's preferred temperature set point and the first user's selected contribution to the environmental factor control device 120, and the second electronic device may send the second user's preferred temperature set point and the second user's selected contribution to the environmental factor control device 120.

In some embodiments, the environmental factor control device 120 may determine the second value based on the selected value and the selected contribution. In some embodiments, the environmental factor control device 120 may calculate the reward for the user based on the second value, the selected value and the selected contribution.

In some embodiments, the environmental factor control device 120 may determine the second value of the environmental factor for the area based on the each user's selected value and the each user's selected contribution. In some embodiments, the environmental factor control device 120 may receive the first user's selected value and the first user's selected contribution from the first electronic device and the second user's selected value and the second user's selected contribution from the second electronic device. In some embodiments, the environmental factor control device 120 may determine the second value based on the first user's selected value and the first user's selected contribution and the second user's selected value and the second user's selected contribution. For example, the environmental factor control device 120 may determine the updated temperature set point for the next time step, based on the first user's preferred temperature set point and the first user's selected contribution and the second user's preferred temperature set point and the second user's selected contribution.

In some embodiments, the environmental factor control device 120 may calculate each user's reward based on the second value of the environmental factor, the each user's selected value, and the each user's selected contribution. In some embodiments, the environmental factor control device 120 may calculate a first user's reward based on the second value of the environmental factor, the first user's selected value and the first user's selected contribution, and calculate a second user's reward based on the second value of the environmental factor, the second user's selected value and the second user's selected contribution. For example, the environmental factor control device 120 may calculate the first user's reward based on the updated temperature set point, the first user's preferred temperature set point and the first user's selected contribution, and the second user's reward based on the updated temperature set point, the second user's preferred temperature set point and the second user's selected contribution.

In some embodiments, the environmental factor control device 120 may determine the second value using a weighted average calculation function based on the selected value and the selected contribution. In some embodiments, the environmental factor control device 120 may determine the second value using the weighted average calculation function based on the each user's selected value and the each user's selected contribution. In some embodiments, the environmental factor control device 120 may determine the second value using the weighted average calculation function based on the first user's selected value and the first user's selected contribution and the second user's selected value and the second user's selected contribution. For example, the environmental factor control device 120 may determine the updated temperature set point using the weighted average calculation function based on the first user's preferred temperature set point and the first user's selected contribution and the second user's preferred temperature set point and the second user's selected contribution.

In some embodiments, the environmental factor control device 120 may use an energy prediction model to predict the at least one of the energy saving and the estimated reward. In some embodiments, the environmental factor control device 120 may predict a baseline energy consumption for the area where the environmental factor service provision device 130 operates at the second value, for example, the updated temperature set point, using the energy prediction model based on at least one of an energy consumption, a baseline value of the environmental factor (also referred to as a “baseline set point”), building design data, and operation condition data. In some embodiments, the energy prediction model may be a machine-learning based model.

In some embodiments, the system 100 may further include an energy measuring device (not shown) which may measure an energy consumption for the area where the environmental factor service provision device 130 operates at the second value, for example, the updated temperature set point. The energy measuring device may provide the information about the measured energy consumption to the environmental factor control device 120.

In some embodiments, the environmental factor control device 120 may calculate a total energy saving based on the measured energy consumption and the predicted baseline energy consumption. In some embodiments, the environmental factor control device 120 may calculate a total cost saving based on the calculated total energy saving.

In some embodiments, the environmental factor control device 120 may calculate the reward for the user using a distribution model based on the calculated total cost saving, the second value, the selected value and the selected contribution. In some embodiments, the environmental factor control device 120 may calculate the reward for each user, using the distribution model based on the calculated total cost saving, the second value, the each user's selected value, and the each user's selected contribution. In some embodiments, the environmental factor control device 120 may calculate the first user's reward using the distribution model based on the second value of the environmental factor, the first user's selected value and the first user's selected contribution, and calculate the second user's reward using the distribution model based on the second value of the environmental factor, the second user's selected value and the second user's selected contribution. For example, the environmental factor control device 120 may calculate the first user's reward using the distribution model based on the updated temperature set point, the first user's preferred temperature set point and the first user's selected contribution, and the second user's reward using the distribution model based on the updated temperature set point, the second user's preferred temperature set point and the second user's selected contribution.

In some embodiments, the environmental factor control device 120 may observe a change between the first value (i.e. the initial value of the environmental factor for the area at which the environmental factor service provision device 130 operates as a first setting) and the second value (i.e. the determined value of the environmental factor for the area at which the environmental factor service provision device 130 operates as a second setting) and a change of the total cost saving, and then update the distribution model using a reinforcement learning function based on the observation. For example, the environmental factor control device 120 may observe the difference in temperature set point between two time steps, and the difference in the total cost saving between the two time steps. The environmental factor control device 120 may then update the distribution model using the reinforcement learning function based on the observation.

In some embodiments, the environmental factor control device 120 may send the calculated reward for the user and the second value to the electronic device 110. In some embodiments, the environmental factor control device 120 may send the first user's reward and the second value to the first electronic device, and send the second user's reward and the second value to the second electronic device. For example, the environmental factor control device 120 may send the first user's reward and the updated temperature set point to the first electronic device, and send the second user's reward and the updated temperature set point to the second electronic device. Therefore, the first user may notice the first user's reward and the updated temperature set point, and the second user may notice the second user's reward and the updated temperature set point.

Although the embodiments are described in a context of temperature control, it may be appreciated that the system 100 according to various embodiments may be used to any other types of the building control parameter. For example, the system 100 may be used to control the temperature of a heating and/or cooling system, the humidity level, the ventilation rate, the light level (for example, turning on/off, dimming, etc.), and any combination thereof. As an example, the user may input the preferred temperature set point and a preferred ventilation rate on the user interface.

As described above, the system 100 according to various embodiments may predict the energy saving of the set point using the pre-defined energy prediction model and send the predicted energy saving to the electronic device 110 for displaying the same for the user. The system 100 according to various embodiments may predict the reward of set point selections and contributions of the users, and send the predicted reward to the electronic device 110 for displaying the same for the user. The system 100 according to various embodiments may update the set point after receiving the user preferences and contributions of each time step, based on the user preferences and contributions of each time step. The system 100 according to various embodiments may predict the baseline energy consumption using the pre-defined energy prediction model. The system 100 according to various embodiments may distribute the cost saving based on a first policy created by a predetermined process. Accordingly, the system 100 according to various embodiments may collaboratively address concerns regarding energy efficiency, cost and user satisfaction.

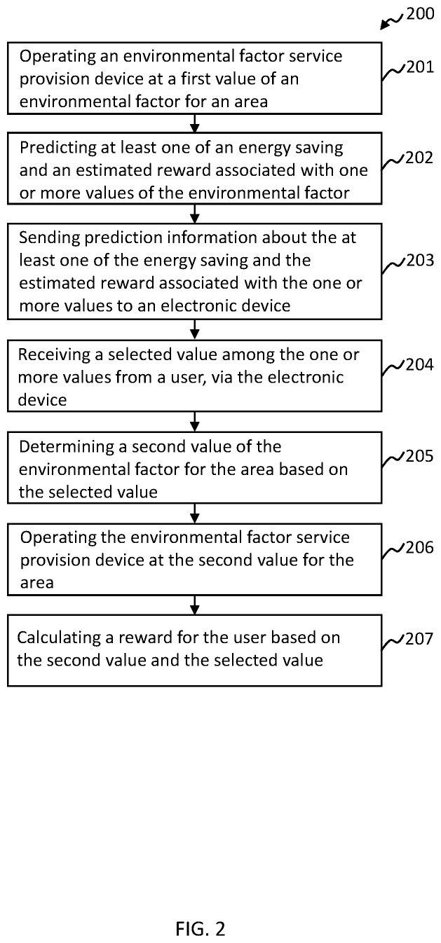

FIG. 2 is a flow diagram illustrating a method according to various embodiments. According to various embodiments, the method 200 for controlling an environmental factor for an area is provided.

In some embodiments, the method 200 may include a step 201 of operating an environmental factor service provision device at a first value of the environmental factor for the area.

In some embodiments, the method 200 may include a step 202 of predicting at least one of an energy saving and an estimated reward associated with one or more values of the environmental factor.

In some embodiments, the method 200 may include a step 203 of sending prediction information about the at least one of the energy saving and the estimated reward associated with the one or more values to an electronic device, so that the electronic device outputs the prediction information associated with the one or more values.

In some embodiments, the method 200 may include a step 204 of receiving a selected value among the one or more values from a user, via the electronic device.

In some embodiments, the method 200 may include a step 205 of determining a second value of the environmental factor for the area based on the selected value.

In some embodiments, the method 200 may include a step 206 of operating the environmental factor service provision device at the second value of the environmental factor for the area.

In some embodiments, the method 200 may include a step 207 of calculating a reward for the user based on the second value and the selected value.

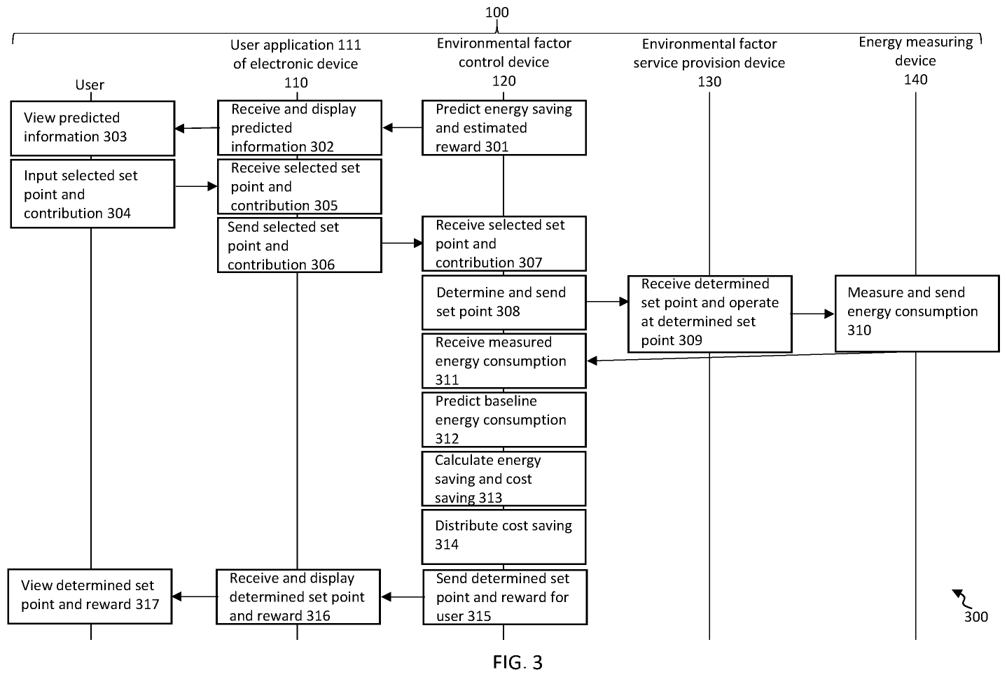

FIG. 3 is a sequence diagram illustrating interactions between a user application 111 of an electronic device 110, an environmental factor control device 120, an environmental factor service provision device 130, and an energy measuring device 140. The sequence diagram may show a method 300 for controlling an environmental factor for an area.

In some embodiments, a system 100 according to various embodiments includes the electronic device 110 which can be used by a user, the environmental factor control device 120 (also referred to as a “control system”), the environmental factor service provision device 130 (also referred to as a “building service system” or a “BSS”), and the energy measuring device 140 (also referred to as an “energy meter”). The user application 111 may be installed in the electronic device 110. The environmental factor control device 120 may communicate with the electronic device 110 via the user application 111. The system may include a plurality of electronic devices 110 each belonging to a plurality of users.

In some embodiments, the method 300 may include a step 301 of which the environmental factor control device 120 predicts an energy saving and an estimated reward of set points and contributions of users. In some embodiments, the contribution may be an amount of payment from the user to the environmental factor control device 120. The user's contribution may add weight to the user's selected set point in determining a final set point by the environmental factor control device 120. In some embodiment, the user may only submit the user's selected set point while the contribution is not configured as an input of the system 100.

In some embodiments, the method 300 may include a step 302 of which the user application 111 receives the predicted energy saving and the estimated reward from the step 301, and displays the predicted information for the user. In some embodiments, predicting and sending the energy saving and the estimated reward may be performed as two steps. For example, first, the environmental factor control device 120 may predict the energy saving and send the energy saving to the user application 111. Then, the environmental factor control device 120 may predict the reward and send the estimated reward to the user application 111. In some other embodiments, predicting and sending the energy saving and the estimated reward may be performed as one step. For example, the environmental factor control device 120 may predict the energy saving and the estimated reward, and send the predicted energy saving and the estimated reward to the user application 111 at the same time.

In some embodiments, the method 300 may include a step 303 of which the user views the predicted energy saving and the estimated reward of set points and contributions.

In some embodiments, the method 300 may include a step 304 of which the user inputs the user's selected (preferred) set point and the user's selected contribution in the user application 111.

In some embodiments, the method 300 may include a step 305 of which the user application 111 receives the user's selected set point and the user's selected contribution from the user.

In some embodiments, the method 300 may include a step 306 of which the user application 111 sends the user's selected set point and the user's selected contribution to the environmental factor control device 120.

In some embodiments, the method 300 may include a step 307 of which the environmental factor control device 120 receives the user's selected set point and the user's selected contribution from the user application 111.

In some embodiments, the method 300 may include a step 308 of which the environmental factor control device 120 determines the set point based on the user's selected set point and the user's selected contribution, and sends a set point control signal to the respective environmental factor service provision device 130.

In some embodiments, the method 300 may include a step 309 of which the environmental factor service provision device 130 receives the set point control signal from the environmental factor control device 120, and operates at the set point.

In some embodiments, the method 300 may include a step 310 of which the energy measuring device 140 measures an energy consumption of the environmental factor service provision device 130, and sends measured energy consumption data to the environmental factor control device 120.

In some embodiments, the method 300 may include a step 311 of which the environmental factor control device 120 receives the measured energy consumption data from the energy measuring device 140.

In some embodiments, the method 300 may include a step 312 of which the environmental factor control device 120 predicts a baseline energy consumption using a pre-defined building energy prediction model.

In some embodiments, the method 300 may include a step 313 of which the environmental factor control device 120 calculates an energy saving and a cost saving based on at least one of the measured energy consumption data, the predicted baseline energy consumption, and energy price.

In some embodiments, the method 300 may include a step 314 of which the environmental factor control device 120 distributes the cost saving among a building owner and the user(s) based on a first cost saving distribution policy created by a pre-determined reinforcement learning process. The cost saving which is distributed to the user(s) may be the reward to be received by the user(s).

In some embodiments, the method 300 may include a step 315 of which the environmental factor control device 120 sends the set point information of the step 308 and the user's reward information of the step 314 to the user application 111.

In some embodiments, the method 300 may include a step 316 of which the user application 111 receives the set point information and the user's reward information from the environmental factor control device 120, and displays the information.

In some embodiments, the method 300 may include a step 317 of which the user views the set point information and the user's reward information on the user application 111. In some embodiment, the set point information may be sent to the user application 111 after the set point information is determined in step 308 so that the user is able to view the set point information earlier than the user's reward information.

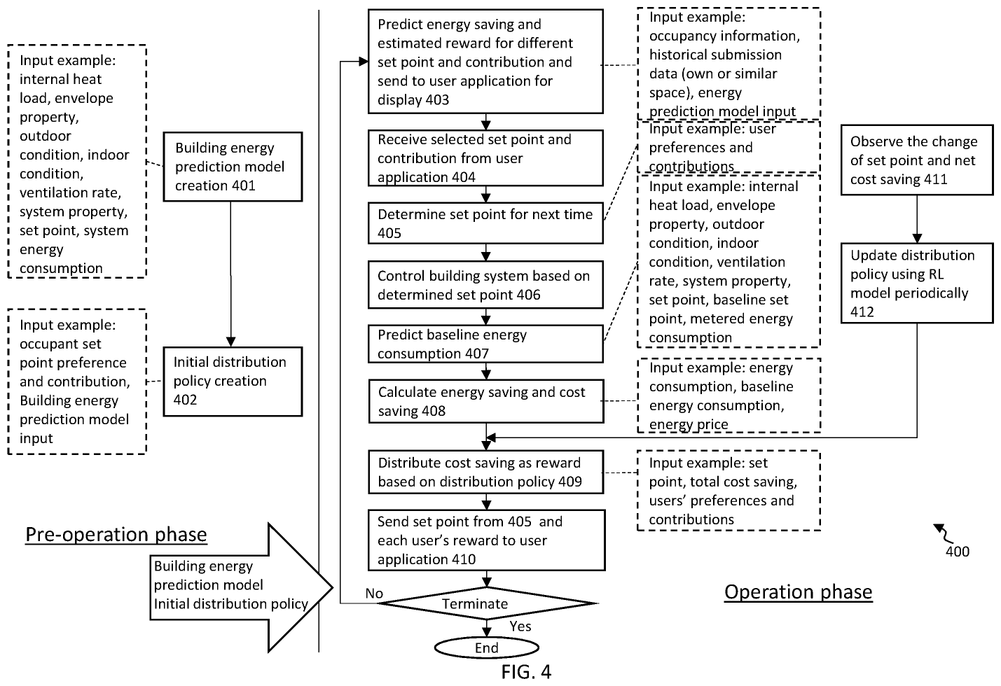

FIG. 4 is a flow diagram illustrating a method 400 according to various embodiments. According to various embodiments, the method 400 for controlling an environmental factor for an area is provided. As shown in FIG. 4, there may be two phases which include a pre-operation phase including steps 401 and 402, and an operation phase including steps 403 to 412.

Although not shown, in some embodiments, the system according to various embodiments include an electronic device 110 which can be used by a user, an environmental factor control device 120 (also referred to as a “control system”), an environmental factor service provision device 130 (also referred to as a “building service system” or a “BSS”) and an energy measuring device 140 (also referred to as an “energy meter”). A user application 111 may be installed in the electronic device 110. The environmental factor control device 120 may communicate with the electronic device 110 via the user application 111. The system may include a plurality of electronic devices 110 belonging to a plurality of users.

In some embodiments, the method 400 may include a step 401 of which a machine learning-based building energy prediction model is created using data related to a building design and operation condition. The data related to the building design and operation condition may include, but not be limited to, at least one of an internal heat load, an envelope property, an outdoor condition, an indoor condition, a ventilation rate, a system property, a set point, and a system energy consumption. In some embodiments, the data may be obtained from at least one of a testbed, a data sharing platform, and other available database. In some embodiments, the data may be collected from a target building. A general process of the machine learning model creation may be employed to create the energy prediction model. The general process may include, but not be limited to, a data collection, a data cleaning and a feature engineering, a model building and selection of a machine learning algorithm, and a model evaluation. In some embodiments, the building energy prediction model may be updated periodically in the operation phase, with new data collected in the operation phase.

In some embodiments, the method 400 may include a step 402 of which an initial cost saving distribution policy is created. An example method of creating the initial cost saving distribution policy may be using a reinforcement learning approach by observing changes of users' set point preferences in response to different cost saving distribution policies. An optimal distribution policy may maximize energy efficiency and a building owner's cost saving.

In some embodiments, the method 400 may include a step 403 of predicting and providing the users with information on potential energy savings and rewards of different set point options, to allow the users to make informed decisions. The users may then proactively request desired (preferred) set point, for example, considering their own comfort, potential rewards and energy savings, for a next time step onwards or a scheduled time period. For an case of explanation, a term of “time step” is used to represent a time period of completing one cycle of set point control. The time step may be a fixed time period, for example, 1 hour, or a flexible time period, for example, a time period for a meeting. In some embodiments, the predicted energy savings of the different set points may be generated by applying the pre-defined machine learning-based energy prediction model in step 401. In some embodiments, the predicted rewards of the different set points and the contributions may be generated by applying a machine learning-based model, which may be created using historical results. In some embodiments, the predicted rewards of the different set points and the contributions may be generated by applying a cost saving distribution policy using at least one of occupancy information, preference distribution information, predicted energy savings, and cost savings.

In some embodiments, the method 400 may include a step 404 of which the control system 120 receives the users' set point preferences and contributions from the user applications 111.

In some embodiments, the method 400 may include a step 405 of which an optimal set point is determined for each time step based on users' submissions including preferred set point and contributions. The optimal set point may be calculated using weighted average values of all the users' submissions to maximize the overall satisfaction rate.

In some embodiments, the method 400 may include a step 406 of which the control system 120 controls the set point of the respective BSS 130, for example, an HVAC system.

In some embodiments, the method 400 may include a step 407 of which a baseline energy consumption is predicted using the pre-defined machine learning-based energy prediction model of step 401.

In some embodiments, the method 400 may include a step 408 of which an energy saving is calculated using the predicted baseline energy consumption of step 407 and an actual measured energy consumption. The cost saving may be calculated based on energy savings, which is based on a set point change from a baseline set point.

In some embodiments, the method 400 may include a step 409 of which cost savings are first distributed between the building owner and all the users using the optimal distribution policy created in step 402, which aims to encourage the users to submit energy efficient set points while maximizing the building owner's net cost savings. The portion of cost savings for the users may then be distributed to each user as rewards based on their contributions to the cost savings to guarantee fairness among the users.

In some embodiments, the method 400 may include a step 410 of which the control system 120 sends the set point determined in step 405 and the users' rewards distributed in step 409.

In some embodiments, the distribution policy may be updated periodically in step 412 using a reinforcement learning method by observing the change of the set point and the net cost savings in step 411.

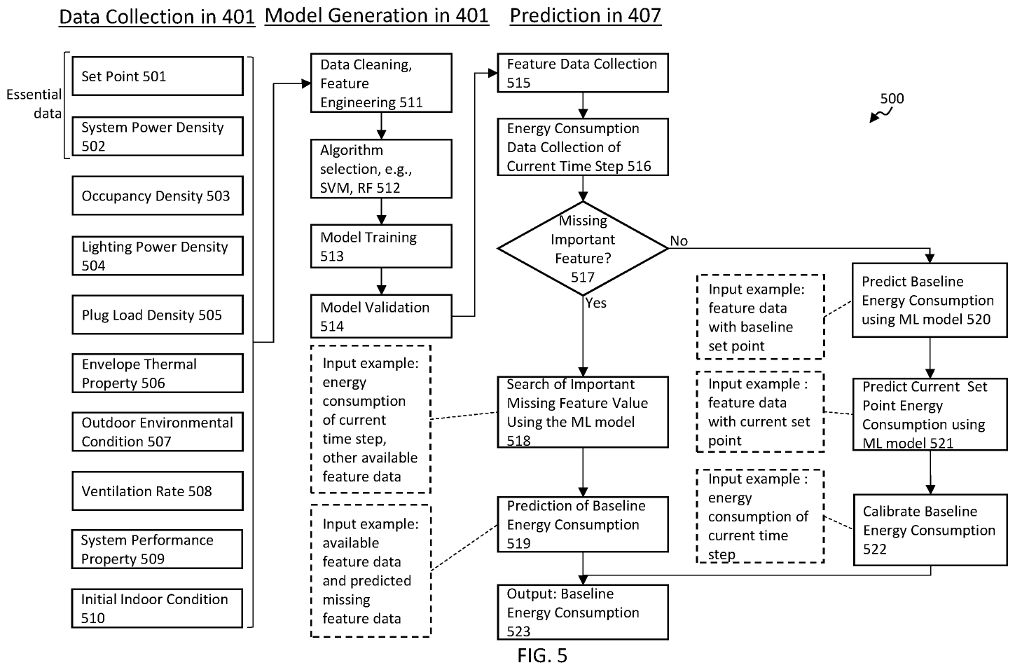

FIG. 5 is a flow diagram illustrating a method 500 according to various embodiments. FIG. 5 shows a process of a machine learning-based building energy prediction model generation in step 401 of FIG. 4 and prediction of the baseline energy consumption in step 407 of FIG. 4.

In some embodiments, data which may be needed to generate the machine learning-based building energy prediction model may comprise a set point 501 and a system power density 502. The system power density 502 may be derived from a system energy consumption per unit time and a respective service area. In some embodiments, the data comprising the set point 501 and the system power density 502 may be referred to as essential data.

In some embodiments, non-essential data may be collected and used to improve model prediction accuracy. The non-essential data may relate to building design and operation conditions including, but not limited to, at least one of an occupancy density 503, a lighting power density 504, a plug load density 505, an envelope thermal property 506 (for example, u-value (thermal transmittance) and/or SHGC (solar heat gain coefficient) of fenestrations), an outdoor environmental condition 507 (for example, an outdoor temperature and/or an outdoor relative humidity), a ventilation rate 508, a system performance property 509 (for example, a system efficiency), and an initial indoor condition 510 (for example, an initial indoor temperature).

In some embodiments, the essential data and the non-essential data may be collected from multiple sources including, but not limited to, at least one of a testbed, a data sharing platform, other available database, and a target building's BMS (building management system). In some embodiments, an actual data type used to generate the machine learning-based building energy prediction model (also referred to as a “model” in FIG. 5) may vary based on a data availability.

In some embodiments, the method 500 may include a step 511 of which a data cleaning and a feature engineering are conducted based on the essential data 501 and 502 and/or the non-essential data 503 to 510.

In some embodiments, the method 500 may include a step 512 of which a candidate machine learning algorithm is selected. The candidate machine learning algorithm may include, but not be limited to, at least one of a Support Vector Machine (SVM), a Random Forest (RF), and a Multilayer Layer Perceptron (MLP).

In some embodiments, the method 500 may include a step 513 of which a model training is conducted.

In some embodiments, the method 500 may include a step 514 of which a model validation is conducted. Multiple models may be created to adapt to different levels of data availability in different buildings.

In some embodiments, in an operation phase, the method 500 may include a step 515 of which feature data types are collected in the target building.

In some embodiments, the method 500 may include a step 516 of which energy consumption data of a current time step is collected.

In some embodiments, the method 500 may include a step 517 of checking whether any important feature is missing. Depending on whether any important feature is missing, different approaches of prediction may be employed. The important feature may include a feature which has very high impact on an output accuracy. It may be identified using a domain knowledge and/or a feature importance study. For the building energy prediction, the important features may include, but not be limited to, at least one of an occupancy density, an outdoor environmental condition, and an initial indoor condition.

In some embodiments, if there is an important feature missing, the method 500 may include a step 518 of which a value of the missing feature is searched (tested out or identified) from a potential value range using the building energy predict model generated in step 401 of FIG. 4 based on a measured energy consumption of the current time step (i.e. the output of the model), and other available features' data (i.e. other input of the model).

In some embodiments, the method 500 may include a step 519 of which a baseline energy consumption data is predicted by the building energy prediction model using the predicted missing feature data and other available features' data.

In some embodiments, if there is no important feature missing, the method 500 may include a step 520 of which the building energy prediction model is used to predict the baseline energy consumption.

In some embodiments, the method 500 may include a step 521 of which the building energy prediction model is used to predict a current set point energy consumption.

In some embodiments, the method 500 may include a step 522 of which the baseline energy consumption is calibrated using the measured energy consumption and the predicted energy consumption of the current set point. A mathematical equation to calibrate the baseline energy consumption is as follows:

$${E}_{b} = {e}_{b} - {E}_{c} / {e}_{c}$$

where E_{b} is the calibrated baseline energy consumption, E_{c} is the measured current set point energy consumption, and e_{b} and e_{c} are the predicted baseline energy consumption in step 520 and the predicted current set point energy consumption in step 521, respectively.

In some embodiments, the method 500 may include a step 523 of which the resulted baseline energy consumption in step 519 or step 522 is used as an output of the prediction.

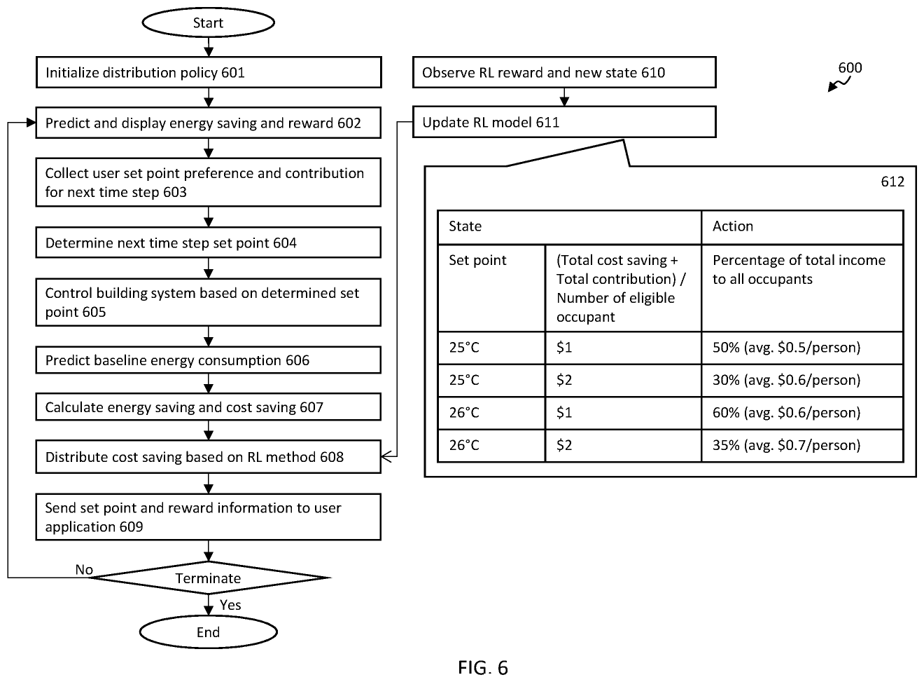

FIG. 6 is a flow diagram illustrating a method 600 according to various embodiments. FIG. 6 illustrates a process of creating a first cost savings distribution policy for a cost saving distribution between a building owner and users.

In some embodiments, although not shown, a system according to various embodiments includes an electronic device 110 which can be used by a user, an environmental factor control device 120 (also referred to as a “control system”), an environmental factor service provision device 130 (also referred to as a “building service system” or a “BSS”) and an energy measuring device 140 (also referred to as an “energy meter”). A user application 111 may be installed in the electronic device 110. The environmental factor control device 120 may communicate with the electronic device 110 via the user application 111. The system may include a plurality of electronic devices 110 belonging to a plurality of users.

In some embodiments, the method 600 may include a step 601 of which a cost savings distribution policy is initialized.

In some embodiments, the method 600 may include a step 602 of which the control system 120 predicts and provides users with information on potential energy savings and rewards of submission options to allow the users to make informed decisions. The users may then proactively request a preferred (desired) set point, for example, considering their own comfort, potential rewards and energy savings, for a next time step onwards (or a scheduled time period). In some embodiments, predicted energy savings of different set points may be generated by applying the pre-defined machine learning-based energy prediction model in step 401 of FIG. 4. In some embodiments, predicted rewards of the different set points and contributions may be generated by applying at least one of a cost saving distribution policy using occupancy information, preference distribution information, and predicted real-time energy savings, and cost savings.

In some embodiments, the method 600 may include a step 603 of which the control system 120 receives user set point preferences and contributions.

In some embodiments, the method 600 may include a step 604 of which an optimal set point is determined for each time step based on users' submissions including a preferred set point and contributions towards the preferred set point. The optimal set point may be calculated using weighted average values of all the users' submissions to maximize the overall satisfaction rate.

In some embodiments, the method 600 may include a step 605 of which the control system 120 controls the respective BSS 130, for example, an HVAC system, based on the optimal set point determined in step 604.

In some embodiments, the method 600 may include a step 606 of which a baseline energy consumption is predicted using the pre-defined machine learning-based energy prediction model of step 401 of FIG. 4.

In some embodiments, the method 600 may include a step 607 of which an energy saving is calculated using a predicted baseline energy consumption of step 407 of FIG. 4 and an actual measured energy consumption. The cost saving may be calculated based on energy price and energy savings.

In some embodiments, the method 600 may include a step 608 of which cost savings are first distributed between the building owner and all the users using a distribution policy based on RL (reinforcement learning) method. The portion of cost savings for the users may then be distributed to each user as rewards based on their contributions to the cost savings to guarantee fairness among the users.

In some embodiments, the method 600 may include a step 609 of which the control system 120 sends the set point of step 604 and the users' rewards of step 608 to the user application 111.

In some embodiments, the method 600 may include a step 610 of which the reward of the action taken in step 608 is calculated based on a defined RL (reinforcement learning) reward function and a new state as a result of the action taken in step 608 is observed.

In some embodiments, the method 600 may include a step 611 of which the RL (reinforcement learning) model is updated based on the rewards and the new state observed in step 608. In some embodiments, the cost distribution policy, which is based on the RL (reinforcement learning) model, aims to maximize the reward function. In some embodiments, the reward function may include variables related to objectives of the control system 120. The variables may include the set point (to maximize) and the building owner's net income (to maximize), and may also include eligible users' net income (for example, reward minus contribution). In some embodiments, the eligible users may refer to users whose preferred set point is more energy efficient than a baseline. Therefore, in some embodiments, to encourage high contributions towards an energy efficient set point preference, it may be heavily penalized if an eligible users' net income is negative. In addition, in some embodiments, regarding the rewards function, a weight of set point maximization and a building owner's net income maximization may be configured by the building owner to suit their own objectives.

In some embodiments, an exemplary table 612 shows an exemplary cost saving distribution policy. The state includes a “set point” and “(total cost savings+total contributions)/number of eligible occupant (user)”. The action includes a “percentage of a total income to all occupants (users)” which leads to the highest future rewards. The created distribution policy may be used in step 409 of FIG. 4 to distribute cost savings between the building owner and the users. The created distribution policy may be updated in step 412 of FIG. 4 using the same reinforcement learning method.

In some embodiments, the reinforcement learning methods which are used for a cost distribution policy generation may include, but not be limited to, at least one of Actor Critic, Policy Gradient, DQN, VFA, SARSA, Q-learning, Model-based and Model-free Monte Carlo, and Dynamic Programming.

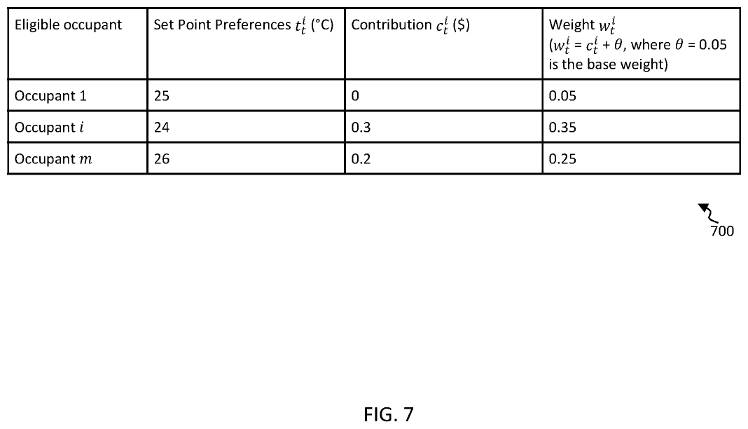

FIG. 7 is a table diagram 700 illustrating a calculation of weight for determining a set point.

In some embodiments, after a cost savings distribution between a building owner and all eligible occupants (users) is performed, a total amount of cost savings distributed to all the eligible users may further be distributed to each of the eligible user as rewards. In some embodiments, the distribution may ensure fairness such that users who contributed more to an energy efficient set point may receive more rewards.

An example of the data used for the cost savings distribution is shown in the table 700. A weight may be calculated for each eligible user's set point preference using a mathematical equation as follows:

$${w}_{t}^{i} = {c}_{t}^{i} + θ$$

where wₜⁱ is a weight of a user i's set point preference at a time step t, cₜⁱ is the user i's contribution at the time step t, and θ is a base weight. As an example, the base weight θ may be set as “0.05”.

If the user i's set point preference tₜⁱ can contribute to energy efficiency than a baseline set point T₀ (for example, tₜⁱ>T₀ for a cooling system, or tₜⁱ<T₀ for a heating system), the user i is eligible for a reward. The reward received by the user i (for both heating system and cooling system) may be calculated using a mathematical equation as follows:

$${v}_{i} = {R}_{t} * \frac{\vert {t}_{t}^{i} - {T}_{0} \vert * {w}_{t}^{i}}{{\sum }_{i = 1}^{m} \vert {t}_{t}^{i} - {T}_{0} \vert * {w}_{t}^{i}}$$

Otherwise (i.e. if the user i is not eligible for the reward),

vᵢ=0

where vᵢ the reward received by the user i, tₜⁱ is the user i's set point preference, T₀ is the baseline set point, wₜⁱ is a weight of the user i's set point preference at a time step t, Rₜ is a total reward to be distributed among all eligible users, and m is a total number of eligible users.

In step 405 of FIG. 4, the set point may be designed to be the weighted average of the users' preference as calculated using a mathematical equation as follows:

$${T}_{t} = \frac{{\sum }_{i = 1}^{n} {t}_{t}^{i} * {w}_{t}^{i}}{{\sum }_{i = 1}^{n} {w}_{t}^{i}}$$

where Tₜ is the set point for the time step t, n is a total number of participating users, tₜⁱ is the user i's set point preference, and wₜⁱ is a weight of the user i's set point preference at a time step t. The set point Tₜ may provide the highest overall satisfaction rate.

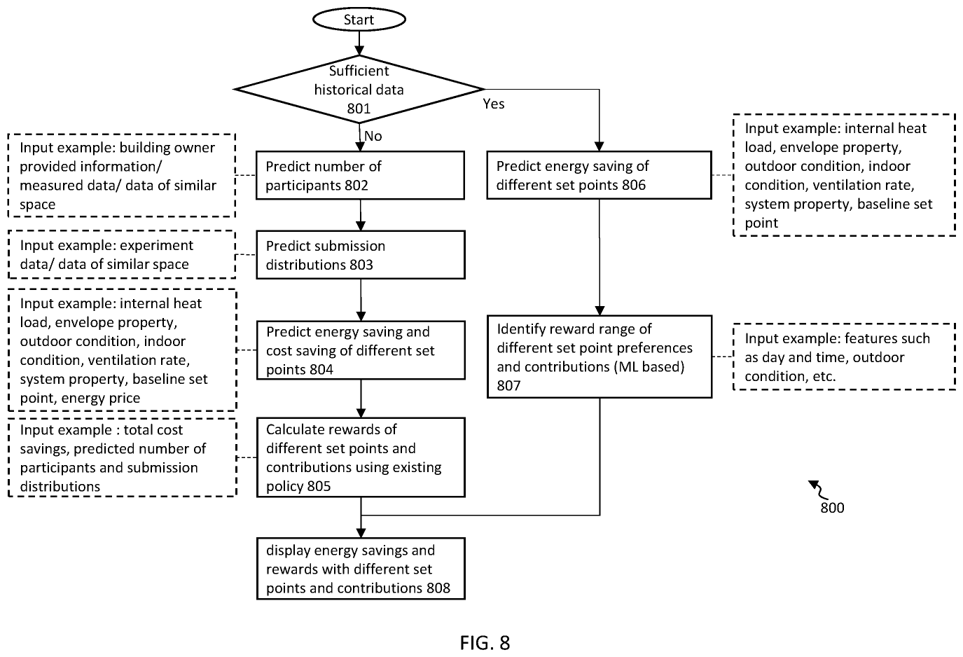

FIG. 8 is a flow diagram illustrating a method 800 according to various embodiments. FIG. 8 illustrates a process of energy savings and rewards prediction of step 403 of FIG. 4.

In some embodiments, the method 800 may include a step 801 of checking whether there is sufficient historical data of users' submissions and resulted rewards to build a machine learning-based model with a reasonable accuracy, for example, 80% accuracy. Depending on whether there is the sufficient historical data of the users' submissions and the resulted rewards to build the machine learning based model with the reasonable accuracy, two different approaches may be applied.

In some embodiments, if there is not sufficient historical data, the method 800 may include a step 802 of which the number of participants (users) may be predicted based on information such as building owner provided information, measured data, and data of similar space.

In some embodiments, the method 800 may include a step 803 of which the distribution of set point preferences and contributions may also be predicted using data available, such as experiment data, and data of similar space.

In some embodiments, the method 800 may include a step 804 of which the energy savings and cost savings of each set point is predicted using a building energy prediction model created in step 401 of FIG. 4 and related data for prediction and calculations, such as building design data, operation condition data, and energy price.

In some embodiments, the method 800 may include a step 805 of which the rewards of set points and the contributions are calculated using an existing policy.

In some embodiments, if there is sufficient historical data, the method 800 may include a step 806 of which the energy savings of set points may be predicted using the building energy prediction model created in step 401 of FIG. 4 and the related data for the prediction.

In some embodiments, the method 800 may include a step 807 of which the reward range of set points and the contributions may be predicted using the machine learning-based model, which is created using the historical data on the users' submissions and resulted rewards. The essential features of the model may include the set point and the contribution. Additional features may include, but not be limited to, at least one of an occupancy density, a day and time, indoor condition, and an outdoor condition.

In some embodiments, the method 800 may include a step 808 of which the energy savings and rewards with different set point and contributions are displayed.

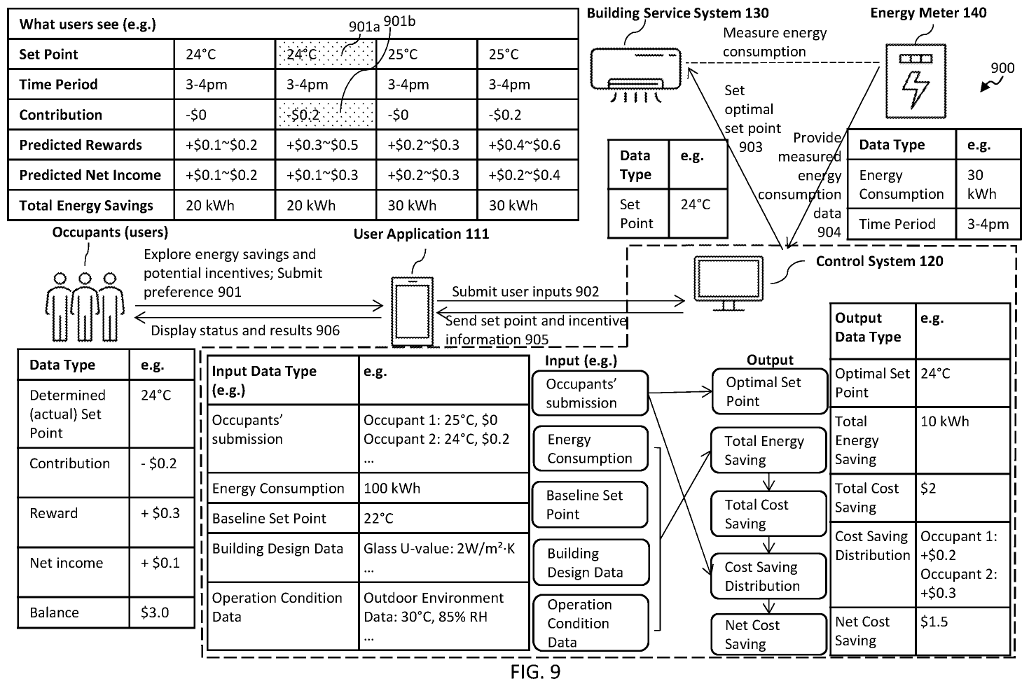

FIG. 9 is an image diagram illustrating a method 900 according to various embodiments. According to various embodiments, the method 900 for controlling an environmental factor for an area is provided.

In some embodiments, the method 900 may include a step 901 of which an occupant (user) explores energy savings and potential incentives and submits preference to a user application 111. In some embodiments, as shown in FIG. 9, the user may select a preferred set point 901a and a contribution 901b towards the preferred set point on a user interface. For example, the user may select “24° C.” as the preferred set point 901a and “$0.2” as the contribution towards “24° C.”. This means that the user has decided to contribute “$0.2” for the preferred set point “24° C.”. As the user interface is provided to the user to select the preferred set point 901a and the contribution 901b, the user may make informed decisions considering at least one of predicted rewards, a predicted net income and total energy savings. In some embodiments, for a cooling system, a higher set point and a higher contribution may lead to a higher net income.

In some embodiments, the method 900 may include a step 902 of which the user application 111 submits the user's inputs to an environmental factor control device (also referred to as a “control system”) 120. In some embodiments, the user application 111 may submit the user's preferred set point and the contribution towards the preferred set point to the control system 120.

In some embodiments, the method 900 may include a step 903 of which the control system 120 sets an optimal set point. In some embodiments, the control system 120 may receive the user's preferred set point and the contribution towards the preferred set point from the user application 111. The control system 120 may set the optimal set point based on the occupants' (users') submission. If a first occupant (also referred to as a “first user”) submits “25° C.” as the preferred set point and “$0” as the contribution towards “25° C.” and a second occupant (also referred to as a “second user”) submits “24° C.” as the preferred set point and “$0.2” as the contribution towards “24° C.”, the control system 120 may set the optimal set point as “24° C.”. The control system 120 may send the optimal set point to an environmental factor service provision device (also referred to as a “building service system”) 130, so that the building service system 130 operates at the optimal set point, for example, “24° C.”.

In some embodiments, the method 900 may include a step 904 of which an energy measuring device (also referred to as an “energy meter”) 140 provides measured energy consumption data. In some embodiments, the energy meter 140 may measure the energy consumption while the building service system 130 operates at the optimal set point, for example, “24° C.”, and then provide the measured energy consumption to the control system 120.

In some embodiments, the method 900 may include a step 905 of which the control system 120 sends the set point and incentive (reward) information to the user application 111. In some embodiments, the control system 120 may calculate a total energy saving based on at least one of an energy consumption, an energy consumption, a baseline value of the environmental factor (also referred to as a “baseline set point”), building design data, and operation condition data. The control system 120 may calculate a total cost saving based on the total energy saving. The control system 120 may calculate a cost saving distribution based on the total cost saving and the users' submission. The control system 120 may calculate a net cost saving based on the cost saving distribution. For example, the control system 120 may calculate the cost saving distribution for the first user, for example, “$0.2” and the cost saving distribution for the second user, for example, “$0.3”. As an example, the control system 120 may calculate the building owner's net cost saving, for example, “$1.5”.

In some embodiments, the method 900 may include a step 906 of which the user application 111 displays a status and results. In some embodiments, as shown in FIG. 9, the user application 111 may display the determined (actual) set point, for example, “24° C.”, and the user's selected contribution, for example, “$0.2”. For example, as the distributed reward for the user is “$0.3”, the net income for the user (for example, the second user) may be “$0.1” which is a difference between the reward and the contribution.

As described above, according to various embodiments, a machine learning approach may be used to predict real-time energy savings with a higher accuracy. The users are able to proactively request the set point for better energy efficiency and benefit from the cost savings. In addition, according to various embodiments, user satisfaction, energy efficiency and net cost savings may be optimized in dynamic environment, using dynamic set point and optimal distribution policy of cost savings. Advantageously, according to various embodiments, a thermal comfort model may not be required to determine the set point, and thus related data (for example, human vital signs) may not be required. Therefore, errors resulting from the thermal comfort model may be avoided.

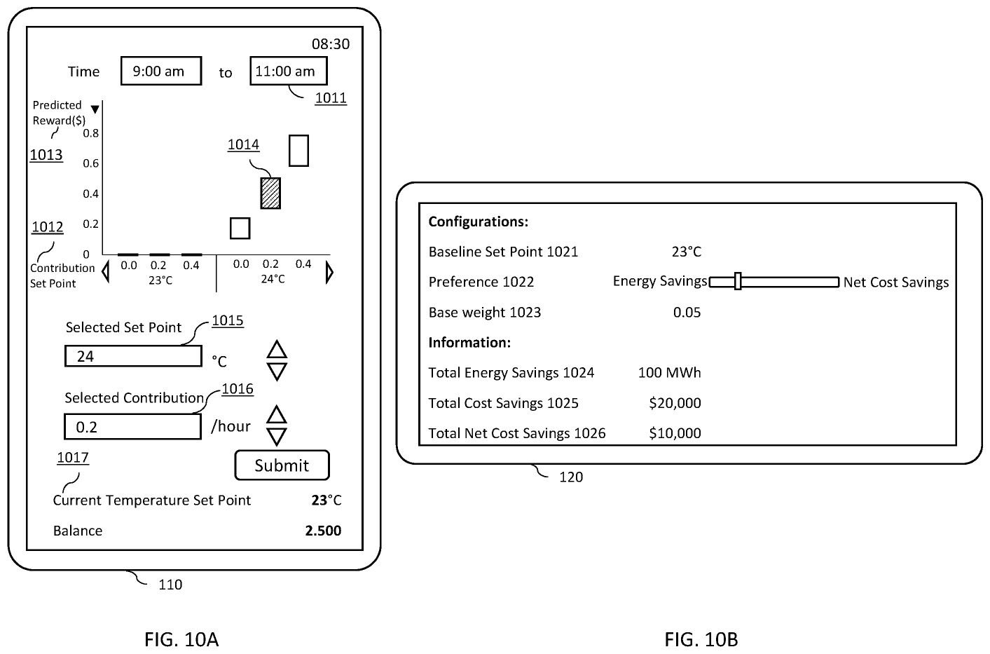

FIG. 10A is an image diagram illustrating a user experience screen according to various embodiments. FIG. 10A illustrates an exemplary user experience screen of an electronic device 110 which can be used by a user.

In some embodiments, the user experience screen of the electronic device 110 may display an image object 1011 associated with a time period during which the user's submission may take effect. In some embodiments, the time period may be configured by the user. In some embodiments, the time period may be dynamic, for example, based on a booking schedule of a shared space.

In some embodiments, the user experience screen of the electronic device 110 may display image objects 1012, 1013, 1014 associated with predicted information of different submission options for the user's submission. For example, the image object 1012 relates to set point options and contribution options, which are shown along an x-axis. The image object 1013 relates to information including predicted rewards, predicted net income and predicted total energy savings, which may be shown at the same time or separately by configuring a y-axis. The image object 1014 relates to the predicted value and/or range of each submission options, and the user may select respective submission option by selecting the image object 1014.

In some embodiments, once the image object 1014 is selected, the respective submissions may be displayed on the user experience screen of the electronic device 110 as an image object 1015 relating to a selected set point and an image object 1016 relating to a selected contribution. In some embodiments, the user may adjust the selected set point and/or the selected contribution by direct editing or using arrow buttons on the user experience screen of the electronic device 110.

In some embodiments, other information including, but not limited to, a current set point and an account balance may be displayed in an area 1017 of the user experience screen of the electronic device 110.

FIG. 10B is an image diagram illustrating a user experience screen according to various embodiments. FIG. 10B illustrates an exemplary user experience screen of an environmental factor control device 120 belonging to a building owner/facility manager. In some embodiments, the environmental factor control device 120 may include one or more client devices (as will be described with FIG. 11).

In some embodiments, configurations of the user experience screen of the environmental factor control device 120 may be done for a baseline set point 1021, a preference towards energy savings versus net cost savings 1022, and a base weight 1023.

In some embodiments, the building owner/facility manager may adjust the baseline set point 1021. This adjustment may update related calculations of energy savings.

In some embodiments, the building owner/facility manager may adjust the preference towards energy savings versus net cost savings 1022. This adjustment may update the reward function of reinforcement learning, and hence the respective cost distribution policies.

In some embodiments, the building owner/facility manager may adjust the base weight 1023. This adjustment may update calculations which uses the base weight θ, including calculations of a set point and cost saving distributions among the eligible users.

In some embodiments, additional information may be displayed on the user experience screen of the environmental factor control device 120. The additional information may include, but not be limited to, at least one of total energy savings 1024, total cost savings 1025, and total net cost savings 1026.

FIG. 11 is a block diagram illustrating an environmental factor control device 120 (also referred to as a “control system”) according to various embodiments.

In some embodiments, the control system 120 may include a user input device and/or peripheral devices 1101. In some embodiments, the user input device and/or peripheral devices 1101 may include, but not be limited to, at least one of the following: a mouse, a keyboard, a touchscreen, and a card reader. In some embodiments, the user input device and/or peripheral devices 1101 may be connected to an input output interface 1104.

In some embodiments, the control system 120 may include one or more client devices 1102. In some embodiments, the client devices may include, but not be limited to, at least one of the following: a mobile phone, a tablet computer, a laptop computer, a desktop computer, a head-mounted display and a smart watch. In some embodiments, the client devices 1102 may be connected to a network interface 1105 via a communication network 1103 (for example, Ethernet, etc.). In some embodiments, the building owner/facility manager may input commands using the user input device and/or peripheral devices 1101 and/or the client devices 1102.

In some embodiments, an interface bus 1107 may connect the input output interface 1104, the network interface 1105, and a storage interface 1106, to allow exchanges of data and/or information among the interfaces 1104, 1105, 1106.

In some embodiments, a system bus 1108 may connect a counter/timer 1109, a CPU 1110, a memory 1111 and the interface bus 1107, to allow exchanges of data and/or information among the counter/timer 1109, the CPU 1110, the memory 1111 and the interface bus 1107.

In some embodiments, a storage device 1112 may be connected to the storage interface 1106. The storage device 1112 may include a set point control module 1113, an energy prediction module 1114, a rewards prediction module 1115 (including sub-functions of a participant number prediction 802 and/or a submission distribution prediction 803 of FIG. 8), an energy and cost saving module 1116, a reinforcement learning module 1117, a cost saving distribution module 1118, and a database 1119. The data base 1119 may include data including, but not limited to, energy and cost prediction related data 1119a, reinforcement learning related data 1119b, user profile data 1119c, and user submission and result data 1119d.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A system for controlling an environmental factor for an area, the system comprising:
an environmental factor control device connectable to an electronic device configured to receive an input from a user,
wherein the environmental factor control device is configured to predict at least one of an energy saving and an estimated reward associated with one or more values of the environmental factor, send prediction information about the at least one of the energy saving and the estimated reward associated with the one or more values to the electronic device, receive a selected value among the one or more values from the electronic device, determine a value of the environmental factor for the area based on the selected value, and calculate a reward for the user based on the determined value of the environmental factor for the area and the selected value.

2. The system according to claim 1, wherein the environmental factor control device is configured to receive the selected value and a selected contribution for the selected value from the electronic device, determine the value based on the selected value and the selected contribution, and calculate the reward for the user based on the determined value, the selected value and the selected contribution.

3. The system according to claim 2, wherein the environmental factor control device is configured to determine the value using a weighted average calculation function based on the selected value and the selected contribution.

4. The system according to claim 2, wherein the environmental factor control device is configured to use an energy prediction model to predict the at least one of the energy saving and the estimated reward.

5. The system according to claim 4, wherein the environmental factor control device is further configured to be connectable to an environmental factor service provision device configured to operate at a value of the environmental factor for the area, and
the environmental factor control device is further configured to send the determined value of the environmental factor for the area to the environmental factor service provision device, and predict a baseline energy consumption for the area where the environmental factor service provision device operates at the determined value, using the energy prediction model based on at least one of an energy consumption, a baseline value of the environmental factor, building design data, and operation condition data.

6. The system according to claim 5, wherein the energy prediction model is a machine-learning based model.

7. The system according to claim 5 further comprising an energy measuring device configured to measure an energy consumption for the area where the environmental factor service provision device operates at the determined value, and provide the information about the measured energy consumption to the environmental factor control device.

8. The system according to claim 7, wherein the environmental factor control device is further configured to calculate a total energy saving based on the measured energy consumption and the predicted baseline energy consumption.

9. The system according to claim 8, wherein the environmental factor control device is further configured to calculate a total cost saving based on the calculated total energy saving.

10. The system according to claim 9, wherein the environmental factor control device is configured to calculate the reward for the user using a distribution model based on the calculated total cost saving, the determined value, the selected value and the selected contribution.

11. The system according to claim 10, wherein the environmental factor control device is further configured to observe a change between an initial value of the environmental factor for the area at which the environmental factor service provision device operates as a first setting and the determined value of the environmental factor for the area at which the environmental factor service provision device operates as a second setting and a change of the total cost saving, and update the distribution model using a reinforcement learning function based on the observation.

12. The system according to claim 1, wherein the environmental factor control device is further configured to send the calculated reward for the user and the determined value to the electronic device.

13. A method for controlling an environmental factor for an area, the method comprising:
operating an environmental factor service provision device at a first value of the environmental factor for the area;
predicting at least one of an energy saving and an estimated reward associated with one or more values of the environmental factor;
sending prediction information about the at least one of the energy saving and the estimated reward associated with the one or more values to an electronic device, so that the electronic device outputs the prediction information associated with the one or more values;
receiving a selected value among the one or more values from a user, via the electronic device;
determining a second value of the environmental factor for the area based on the selected value;
operating the environmental factor service provision device at the second value of the environmental factor for the area; and
calculating a reward for the user based on the second value and the selected value.

14. The method according to claim 13, wherein
receiving the selected value from the user comprises: receiving the selected value and a selected contribution for the selected value from the user;
determining the second value comprises: determining the second value based on the selected value and the selected contribution; and
calculating the reward for the user comprises: calculating the reward for the user based on the second value, the selected value and the selected contribution.

15. The method according to claim 14, wherein determining the second value comprises: determining the second value using a weighted average calculation function based on the selected value and the selected contribution.

16. The method according to claim 14, further comprising: displaying the prediction information in a form of a user interface on the electronic device, to allow the user to input the selected value among the one or more values on the user interface.

17. The method according to claim 14, wherein predicting the at least one of the energy saving and the estimated reward associated with the one or more values comprises: using an energy prediction model to predict the at least one of the energy saving and the estimated reward.

18. The method according to claim 17 further comprising: predicting a baseline energy consumption for the area where the environmental factor service provision device operates at the second value, using the energy prediction model based on at least one of an energy consumption, a baseline value of the environmental factor, building design data, and operation condition data.

19. The method according to claim 18, wherein the energy prediction model is a machine-learning based model.

20. The method according to claim 18 further comprising:
receiving, from an energy measuring device, information about a measured energy consumption for the area where the environmental factor service provision device operates at the second value.

21. The method according to claim 20 further comprising: calculating a total energy saving based on the measured energy consumption and the predicted baseline energy consumption.

22. The method according to claim 21 further comprising: calculating a total cost saving based on the calculated total energy saving.

23. The method according to claim 22, wherein calculating the reward for the user comprises: calculating the reward for the user using a distribution model based on the calculated total cost saving, the second value, the selected value and the selected contribution.

24. The method according to claim 23 further comprising:
observing a change between the first value and the second value and a change of the total cost saving; and
updating the distribution model using a reinforcement learning function based on the observation.

25. The method according to claim 13 further comprising: sending the calculated reward for the user and the second value to the electronic device.

26. A system for controlling an environmental factor for an area, the system comprising:
an electronic device configured to receive an input from a user;
an environmental factor service provision device configured to operate at a first value of the environmental factor for the area; and
an environmental factor control device connectable to the electronic device and the environmental factor service provision device,
wherein the environmental factor control device is configured to predict at least one of an energy saving and an estimated reward associated with one or more values of the environmental factor, and send prediction information about the at least one of the energy saving and the estimated reward associated with the one or more values to the electronic device,
the electronic device is configured to output the prediction information associated with the one or more values, receive a selected value among the one or more values from the user, and send the selected value to the environmental factor control device,
the environmental factor control device is further configured to determine a second value of the environmental factor for the area based on the selected value, and send the second value to the environmental factor service provision device,
the environmental factor service provision device is further configured to operate at the second value of the environmental factor for the area upon receiving the second value from the environmental factor control device, and
the environmental factor control device is further configured to calculate a reward for the user based on the second value and the selected value.

27. The system according to claim 26, wherein the electronic device is configured to receive the selected value and a selected contribution for the selected value from the user, and send the selected value and the selected contribution to the environmental factor control device; and
the environmental factor control device is configured to determine the second value based on the selected value and the selected contribution, and calculate the reward for the user based on the second value, the selected value and the selected contribution.

28. The system according to claim 26, wherein the electronic device is configured to display the prediction information associated with the one or more values in a form of a user interface, to allow the user to input the selected value among the one or more values on the user interface.
